(19) United States
(12) Patent Application Publication
(10) Pub. No.: US 2012/0140599 A1
(43) Pub. Date: Jun. 7, 2012

(54) ALARM CLOCK AND METHOD FOR OPERATING SAME

(75) Inventor: MING-YANG LIAO, Tu-Cheng (TW)

(73) Assignee: HON HAI PRECISION INDUSTRY CO., LTD., Tu-Cheng (TW)

(21) Appl. No.: 13/036,017

(22) Filed: Feb. 28, 2011

(30) Foreign Application Priority Data
Dec. 7, 2010 (TW) 99142487

(51) Int. Cl. G04G 13/02; G04C 21/16

(52) U.S. Cl. 368/9

(57) ABSTRACT

An alarm clock includes a main body having a clock dial, an alarm module, a camera module, a storage member and a processor. The alarm module is attached to the main body and for sending out an alarm signal at a preset time. The camera module is rotatably mounted on the main body and for capturing a first image of a predetermined area within a viewing range thereof prior to sending out the alarm signal, and a second image after the alarm signal is sent out. The storage member is configured for storing the first image and the second image. The processor is configured for comparing the second image with the first image to determine if a person is located in the viewing range, and controlling the alarm module and the camera module to operate based on the determined result. An operating method of the alarm clock is also provided.

### BACKGROUND

1. Technical Field

The present disclosure relates to alarm clocks, and particularly to an alarm clock with a camera module, and a method for operating such camera module.

2. Description of Related Art

Alarm clocks providing alarm function and clock function, can serve as timing devices, anti-theft devices and others.

Many alarm clocks may only provide alarms when a time is up, some only give one alarm and others may continue to issue an alarm until being controlled off.

What is needed, therefore, is an alarm clock which can overcome the limitations described.

### BRIEF DESCRIPTION OF THE DRAWINGS

Many aspects of the disclosure can be better understood with reference to the following drawings. The components in the drawings are not necessarily drawn to scale, the emphasis instead being placed upon clearly illustrating the principles of the disclosure. Moreover, in the drawings, like reference numerals designate corresponding parts throughout the several views.

FIG. 1 is a schematic view of an alarm clock in accordance with one embodiment.

FIG. 2 is similar to FIG. 1, but viewed from another aspect to show a rear face of the alarm clock.

FIG. 3 is a block diagram showing main function of the alarm clock of FIG. 1.

FIG. 4 is a flowchart of an operating method of an alarm clock.

### DETAILED DESCRIPTION

Embodiments of the disclosure will now be described in detail and with reference to the drawings.

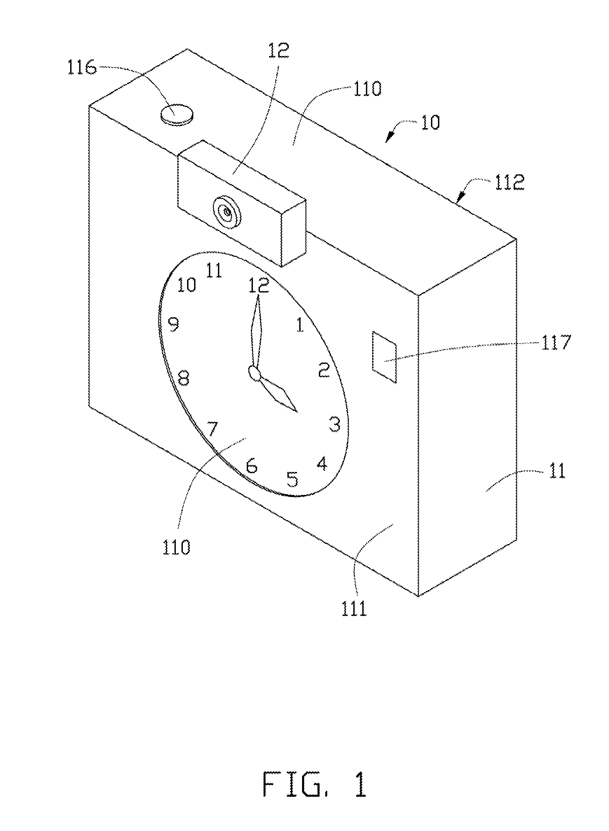

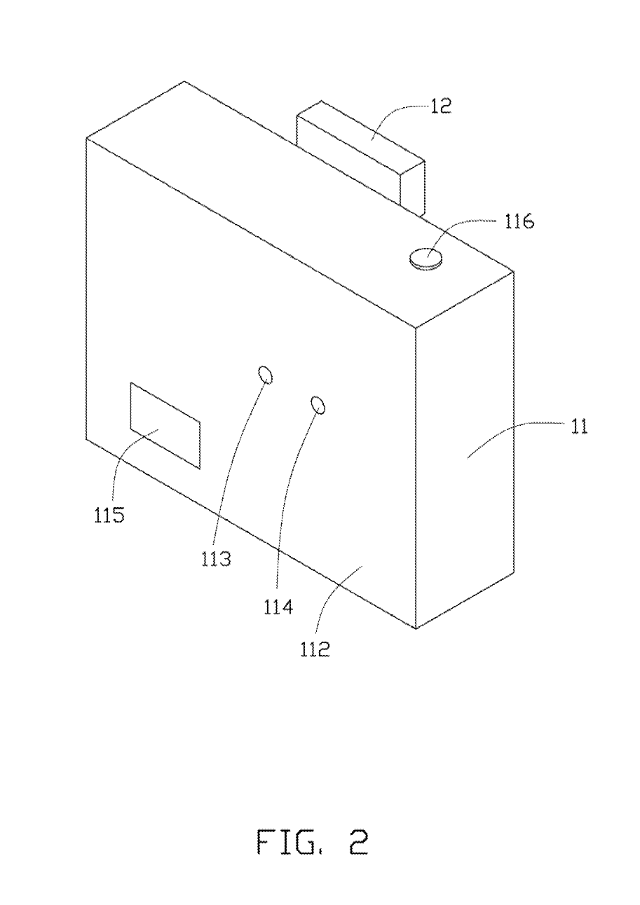

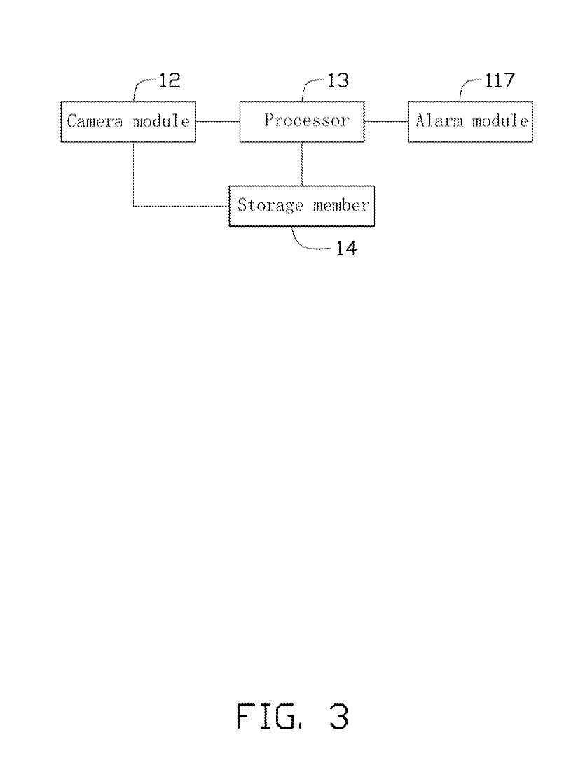

Referring to FIGS. 1 to 3, an exemplary alarm clock 10 includes a main body 11, and a camera module 12 rotatably mounted on the main body 11.

In the present embodiment, the main body 11 is substantially rectangular. In other embodiments, the main body 11 can be other shapes according to need. The main body defines a front surface 111, an opposite rear surface 112, and a top surface 110 interconnecting the front surface 111 and the rear surface 112. The front surface 111 includes a clock dial 110 showing the time, and an alarm module 117. The rear surface 112 includes an alarm time setting control 113, a time regulating control 114, and a battery case 115 arranged thereon.

The clock dial 110 can be designed into any shape, and different marks can be used to mark the time. The alarm module 117 provides audio alarm output. The alarm time setting control 113 allows the alarm time to be set. The time regulating control 114 allows the current time as displayed on the clock dial 110 to be set. The battery case 115 is configured for containing one or more batteries to power the clock dial 110 and the camera module 12.

The camera module 12 is defined at a top of the front surface 111 and extends beyond the top surface 110. A control button 116 is defined on the top surface 110 to activate, initiate operation the camera module 12.

The main body 11 includes a storage member 14 and a processor 13 mounted therein. The storage member 14 is configured for storing images captured by the camera module 12. The processor 13 is configured for processing the images from the storing unit 14, and operating the alarm module 117 and the camera module 12 based thereon.

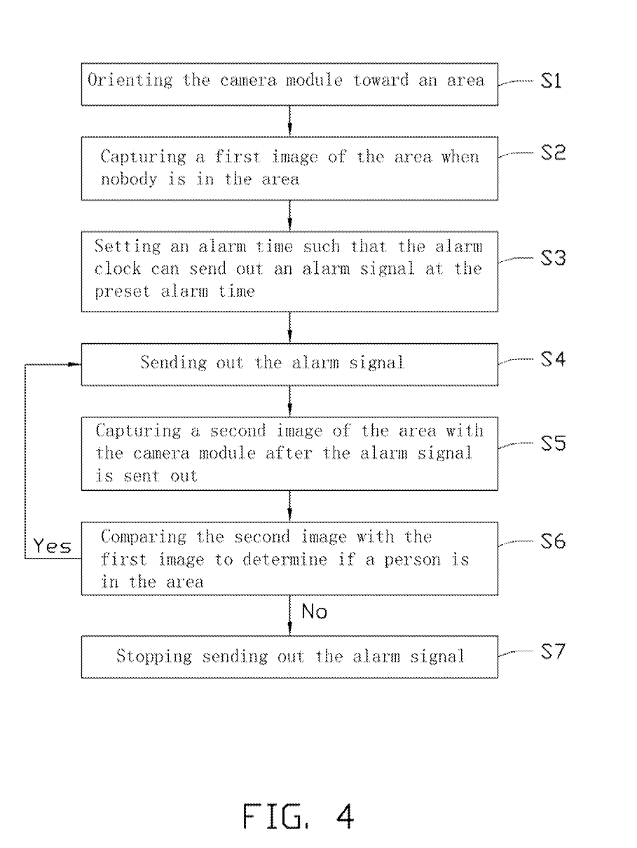

Referring to FIG. 4, a method for operating an alarm clock is as follows.

Firstly, referring to S1, the camera module 12 is adjusted (rotated) to allow the camera module 12 focus on a predetermined subject range (e.g., a sleeping area on bed) when nobody is in the predetermined subject range. Then, a first image of the predetermined subject range when nobody is in the predetermined subject range is captured and stored in the storage member 14.

Secondly, referring to S2, an alarm time is set by the alarm time setting control 113, e.g., six o'clock, seven thirty o'clock and so on.

It is understood that the S2 and S1 can be exchanged.

Then, referring to S3, at a preset time, i.e., when an alarm time is up, and the alarm module 117 gives an alarm signal.

Referring to S4, during the alarm signal, or after a first alarm signal is issued, the camera module 12 may be automatically opened to capture a second image of the predetermined subject range, and the second image is stored in the storage member 14.

Referring to S5, the processor 13 processes the second image by comparing with the first image to identify if a person is in the predetermined subject range. If yes, repeat S3-S5. That is, the processor 13 gives a going on signal to the alarm module 117, and the alarm module 117 goes on giving the alarm signal or giving a second alarm signal; then the camera module 12 captures a third image, and the processor 13 compares the third image with the first image until nobody is identified in the predetermined subject range, i.e, until the currently captured image is the same as the first image. If not, go on to S6, the processor 13 gives a stopping signal to the alarm module 117 and the camera module 12.

Specially, the processor 13 can predetermine a reference difference proportion, e.g., 70% or other appropriate proportions. Then the currently captured image is subtracted to the first image to obtain a difference, and when the difference occupies the area of the currently captured image a proportion greater than 70%, it can be identified that there is somebody in the currently captured image.

In particular, different reference difference proportions are related to different positions of the predetermined subject range, with the closer to a central area of the predetermined subject range the smaller the reference difference proportions. For example, in the wakeup application, at positions closed to the pillow, the reference difference proportion can be smaller, and at positions far away the pillow, the reference difference proportion can be greater.

In conclusion, an alarm clock compares images of a predetermined subject range to decide whether the alarm module 117 is to continue issuing an alarm or stop.

It is understood that the described embodiments are intended to illustrate rather than limit the disclosure. Variations may be made to the embodiments and methods without departing from the spirit of the disclosure. Accordingly, it is appropriate that the appended claims be construed broadly and in a manner consistent with the scope of the disclosure.

What is claimed is:

1. An alarm clock, comprising:
a main body having a clock dial;
an alarm module attached to the main body and configured for sending out an alarm signal at a preset time;
an camera module rotatably mounted on the main body and configured for capturing a first image of a predetermined area within a viewing range thereof prior to sending out the alarm signal, and a second image of the predetermined area after the alarm signal is sent out;
a storage member and a processor in the main body, the storage member configured for storing the first image and the second image, the processor configured for comparing the second image with the first image to determine if a person is located in the viewing range, and controlling the alarm module and the camera module to operate based on the determined result.

2. The alarm clock of claim 1, wherein the main body has a front face and a rear face, both the clock dial and the camera module being arranged at the front face.

3. The alarm clock of claim 2, wherein the main body comprises an alarm time setting control, a time regulating control and a battery case arranged at the rear face.

4. The alarm clock of claim 1, wherein the main body comprises a control button for activating the camera module.

5. A method for operating an alarm clock, the alarm clock having an alarm module and a camera module, the method comprising:
orienting the camera module toward an area
capturing a first image of the area when nobody is in the area;
setting an alarm time such that the alarm clock can send out an alarm signal at the preset alarm time;
capturing a second image of the area with the camera module after the alarm signal is sent out;
comparing the second image with the first image to determine if a person is in the area; and
stopping sending out the alarm signal if nobody is in the area.

6. The method of claim 5, wherein the second image is subtracted from the first image to obtain a difference, and the difference is analyzed to determine if a person is in the area.
